(19) United States
(12) Patent Application Publication
(10) Pub. No.: US 2011/0005905 A1
(43) Pub. Date: Jan. 13, 2011

(54) LOCKING SWITCH DEVICE FOR A POWER TOOL

(75) Inventors: Masatoshi Fukinuki, Nanjing (CN); Guigong Ni, Nanjing (CN)

Correspondence Address: GREENBERG TRAURIG, LLP, 77 WEST WACKER DRIVE, SUITE 3100, CHICAGO, IL, 60601-1732, US

(73) Assignee: CHERVON LIMITED, Wanchai (HK)

(21) Appl. No.: 12/834,205

(22) Filed: Jul. 12, 2010

(30) Foreign Application Priority Data
Jul. 13, 2009 (CN) 200920233046.2

(51) Int. Cl. H01H 9/20

(52) U.S. Cl. 200/43.18

(57) ABSTRACT

A power tool has a housing and the housing includes a handle portion on which a starting switch for controlling the turning-on and turning-off of the power tool is mounted. A locking switch device adapted to selectively inhibit movement of the starting switch is mounted in the housing and includes first and second buttons respectively extending out from the two sides of the handle portion and positioned adjacent to the starting switch. A locking mechanism is arranged between the starting switch and the locking switch device and includes a linkage mechanism that is arranged between the first and second buttons. In this manner, upon one of the first and second button being pressed down, the linkage mechanism functions to cause the other one of the first and second buttons to be automatically moved to a position that corresponds to a pressed down state. The power tool with such a locking switch device is suitable for left-handed and right-handed operators and eliminates any uncomfortable feelings of handling the handle.

### RELATED APPLICATION INFORMATION

This application claims the benefit of CN 200920233046.2, filed on Jul. 13, 2009, the disclosure of which is incorporated herein by reference in its entirety.

### BACKGROUND

The subject disclosure generally relates to power tools and, more particularly, relates to a locking switch device for a power tool.

There are a variety of power tools, which generally comprise a housing, a motor located in the housing, a power supply for supplying electricity to the motor and a cutting tool driven by the motor. The housing includes a handle portion. The power supply can be a DC power supply or an AC power supply. A starting switch for controlling the motor is mounted to the handle portion and, thereby, the user can contact the starting switch by his finger and operate the power tool conveniently when handling the handle portion. For safety, the power tool generally further comprises a locking switch device which can be designed to only have a lock-on function or a lock-off function or be designed to have the two functions simultaneously. The locking switch device having the two functions simultaneously is generally referred to as self-locking or anti self-locking switch device. The locking switch device with lock-on function can lock the starting switch in the switch-on position, that is to say, once the user presses down the starting switch and then presses down the button for locking the switch device, the starting switch can be kept in the switch-on position. The locking switch device with lock-off function can lock the starting switch in the switch-off position, that is to say, the starting switch can be pressed down only when the button for locking the switch device is pressed down, thereby effectively avoiding undesired operations resulting from the starting switch being pressed down accidentally by the user.

In order to be adapted to left-handed operators and right-handed operators, the locking switch devices of some power tools comprise two buttons which are respectively arranged on the two sides of the handle portion and located as close as possible to the starting switch. In this manner, when any user handles the handle portion his thumb will be located adjacent to one of the two buttons while his other fingers will be located adjacent to the starting switch thus allowing any user to operate the locking switch device and starting switch and control the power tool simultaneously by one hand.

In the above existing power tools, the locking switch device is designed to be located as closely as possible to the starting switch. This arrangement, however, also has a deficiency, that is, when the user presses down one locking switch button and the starting switch to operate the power tool, the other locking switch button is under the state of being not pressed down, and projects from the housing and usually leans against the palm of the user, which causes an uncomfortable feeling of handling. This may cause fatigue and abrade the hand of a user.

### SUMMARY

The subject disclosure is directed to an improved power tool having a locking switch device that is convenient for operation, conforms to the principle of human engineering, and improves the comfort of handling. To this end, the subject disclosure describes a power tool having a housing and a power supply. The housing has a handle portion on which is arranged a starting switch for controlling the turning-on and turning-off of the power tool. A locking switch device is arranged in the housing and a locking mechanism is arranged between the starting switch and the locking switch device. The locking switch device comprises a first button and a second button respectively extending out from the two sides of the handle portion and positioned adjacent to the starting switch. A linkage mechanism is arranged between the first button and the second button so that, once one of the first button and the second button is in the state of being pressed down, the other one of the first button and the second button is pressed down automatically.

With the linkage mechanism between the first button and the second button, once one button is pressed down, the other one moves automatically towards the housing and then reaches the state of being pressed down. Thus, when the user handles the device, his palm can snugly contact the surface of the handle portion without having the uncomfortable feeling of an extended switch and the user can operate the power tool more easily. The arrangement disclosed hereinafter thus inherits the advantages in the prior art, i.e., the positional designs of the locking switch device and the starting switch which is convenient for the user to operate by one hand, while eliminating the disadvantage in the prior art, i.e., the uncomfortable feeling of dual switch handling.

### BRIEF DESCRIPTION OF THE DRAWINGS

The present invention will be further described with reference to the accompanying drawings, in which:

FIG. 1 is an illustrative view of a power tool in the exemplary form of a reciprocating saw constructed according to the description that follows;

FIG. 2 is a top view of the reciprocating saw of FIG. 1;

FIG. 3 is an explosive view of the locking switch device of FIG. 1;

FIG. 4 is an assembly view of the locking switch device and the starting switch of FIG. 3, wherein the shaft sleeve is removed;

FIG. 5 is an illustrative view of the first button component of the locking switch device of FIG. 3;

FIG. 6 is an illustrative view of the second button component of the locking switch device of FIG. 3;

FIG. 7 is an illustrative view of the starting switch of FIG. 3;

FIG. 8 is a view illustrating the assembled state of the locking switch device of FIG. 3 and the housing;

FIG. 9 is an illustrative view of a further exemplary locking switch device constructed according to the description that follows; and

FIG. 10 is a view illustrating the assembled state of the locking switch device of FIG. 9 and the housing.

### DETAILED DESCRIPTION

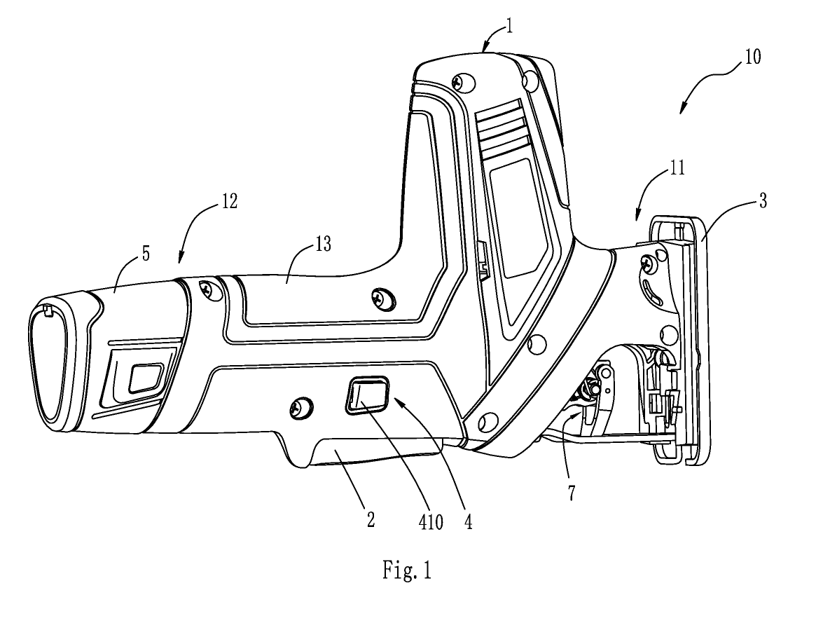

Referring to FIG. 1, the following describes a power tool in the exemplary form of a reciprocating saw having a locking switch device. It will be understood, however, that the described locking switch device can be used with other power tools, such as angle grinders, sanders, drills, etc. without limitation.

As shown in FIG. 1, the reciprocating saw 10 comprises a housing 1, a supporting frame 3, and a power supply portion 5 carrying a power supply. A motor (not shown) is arranged in the housing 1, and the supporting frame 3 and the power supply portion 5 are respectively arranged on the front end 11 and the rear end 12 of the housing 1. In the present embodiment, the power supply carried by the power supply portion 5 is a battery pack, and in other embodiments, the power supply portion 5 may comprise an electrical connecting mechanism for receiving AC power supply or DC power supply. In operation, the supporting frame 3 contacts the material to be cut. The battery pack portion 5 is used for supplying electricity to the motor. A saw blade clamping device 7 is arranged on the front end 11 of the housing 1 for clamping a saw blade (not shown). The saw blade extends towards the exterior of the housing 1 through the supporting frame 3 and is driven by the motor to perform a linear reciprocating movement so as to saw or cut the material.

The housing 1 is formed with a handle portion 13 at a position closer to the rear end 12 of the housing 1. The radial dimension of the handle portion 13 is relative small to allow the handle portion 13 to be handled by a user. The handle portion 13 is provided with a starting switch 2 at a lower end thereof for controlling the turning-on and turning-off of the motor and the whole reciprocating saw. A locking switch device 4 is mounted in the handle portion 13, and a locking mechanism is arranged between the locking switch device 4 and the starting switch 2. In the present embodiment it is only after the locking switch device 4 is operated that the starting switch 2 can be pressed down to start the motor. Thus, the locking switch device 4 is a lock-off locking switch device. In other embodiments, the locking switch device can be designed as a lock-on locking switch device, or a locking switch device having lock-on and lock-off functions simultaneously.

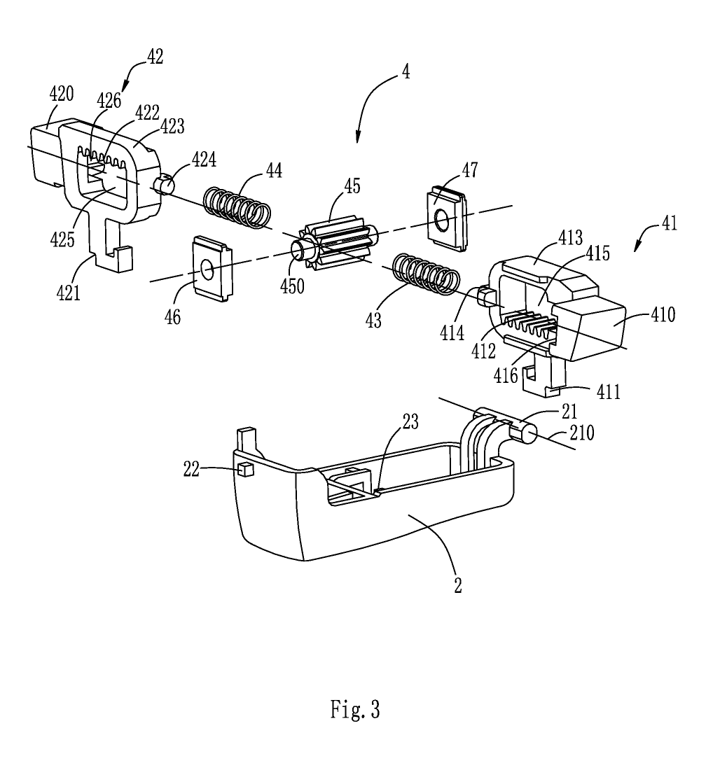

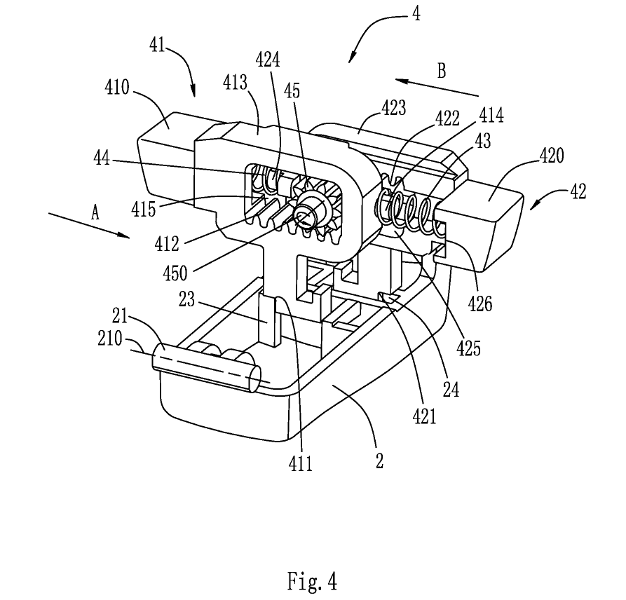

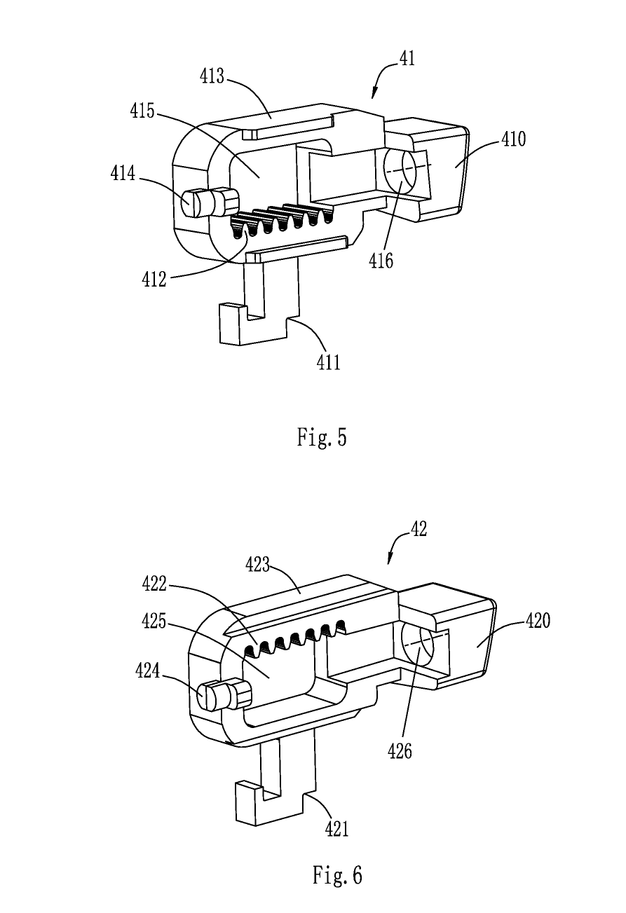

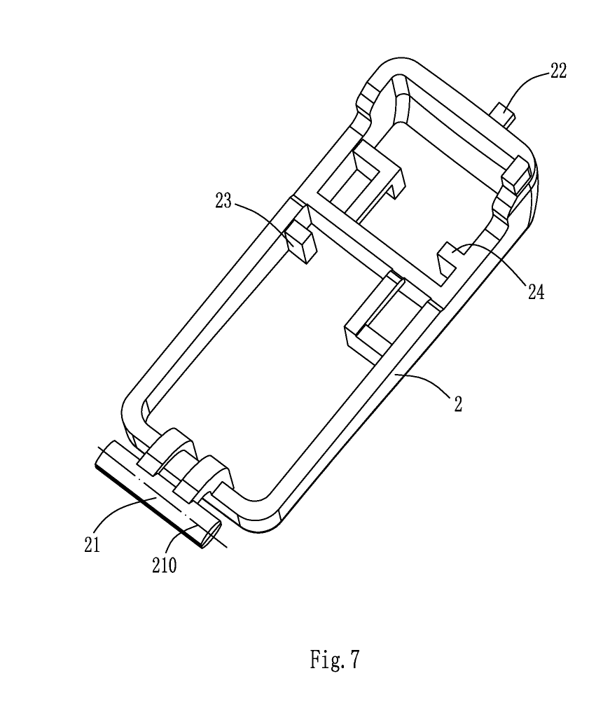

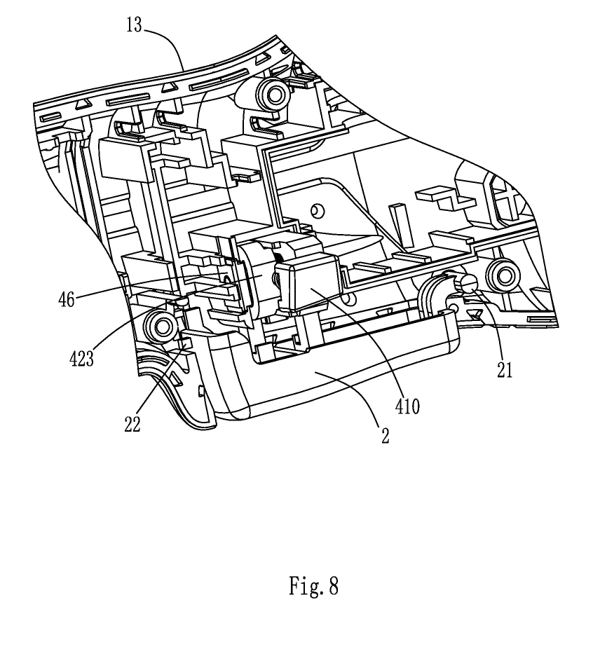

As shown in FIG. 3, the starting switch 2 is a trigger comprising a rotating shaft 21 and a restricting block 22 that are arranged on the two ends of the trigger respectively. The rotating shaft 21 has an axis 210. The starting switch 2 is pivotally mounted on the handle portion 13 by the rotating shaft 21 as shown in FIG. 8. Referring to FIGS. 3 and 4, the locking switch device 4 is mounted above the starting switch 2 and comprises a first button component 41 and a second button component 42. The locking mechanism that is interposed between the locking switch device 4 and the starting switch 2 comprises a first abutting portion 411 and a second abutting portion 421, and a first block 23 and a second block 24 formed on the starting switch 2, as shown in FIGS. 5-7. The first and second abutting portion 411, 421 are respectively formed on the lower ends of the first and second button component 41, 42, and have a generally inverted “L” shape, and are respectively locked and clamped to the first and second block 23, 24, thereby locking the starting switch 2 in the switch-off position. In the switch-off state shown in FIG. 4, the pivoting movement of the starting switch 2 about the axis 210 is stopped by the first and second button component 41, 42 because of the clamping connection between the first and second abutting portion 411, 421 and the first and second blocks 23, 24. In this case, the starting switch 2 cannot be pressed down, thus it avoids operation of the device resulting from a pressing down of the starting switch 2 accidentally by the user. When the locking switch device 4 is operated, the first and second abutting portions 411, 421 move to disengage from the first and second blocks 23, 24, whereupon the starting switch 2 can be pressed down. At this moment, the starting switch 2 can be pivoted about the axis 210 towards the interior of the housing 1 so as to start the motor.

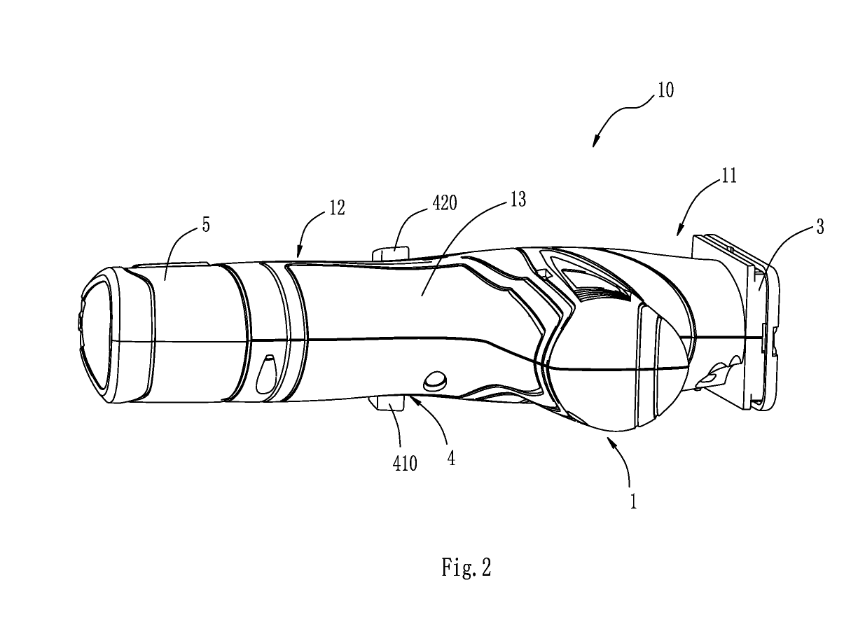

As shown in FIGS. 1 and 2, the first and second button components 41, 42 are formed with a first button 410 and a second button 420 respectively. As shown in FIG. 2, the first and second buttons 410 and 420 project outwardly from the two sides of the handle portion 13 at the position adjacent to the lower end and are close to the starting switch 2. When the user handles the handle portion 13, his thumb is able to be positioned on the first button 410 or the second button 420 with his other fingers being able to be on the starting switch 2. As will be appreciated, such an arrangement enables both left-handed and the right-handed operators to operate and control the reciprocating saw very easily.

As shown in FIGS. 3-6, a linkage mechanism is arranged between the first button 410 and the second button 420. The linkage mechanism functions such that, once one of the first and second buttons 410, 420 is pressed down, the other of the buttons is caused to retract, i.e., move inwardly towards the housing, automatically so as to also achieve a pressed down state. This mechanism thus eliminates the uncomfortable feeling of handling that was found in the prior art. More particularly, the linkage mechanism comprises a first spring 43, a second spring 44 and two gear-rack transmission pairs. In other embodiments, the first and second springs 43, 44 may take the form of other suitable resilient members. The first and second springs 43, 44 act between the first and second buttons 410, 420, so that the first and second buttons 410, 420 tend to move oppositely. The two gear-rack transmission pairs comprise a gear 45 and two racks which are the first and second racks 412, 422 respectively formed on the first and second buttons 41, 42.

The first and second button components 41 and 42 comprise a first component body 413 and a second component body 423 respectively. The first and second buttons 410, 420 and a first and second installation projection 414, 424 are arranged on the two ends of the first and second component bodies 413, 423 respectively. The first and second component bodies 413, 423 have a first through-hole 415 and a second through-hole 425 respectively which are generally rectangular holes. The first and second racks 412, 422 are arranged in the lower side of the first through-hole 415 and the upper side of the second through-hole 425 respectively, and the gear teeth face oppositely. The gear 45 engages with the first and second racks 412, 422 simultaneously.

As shown in FIGS. 3, 4 and 8, in the assembled state, the gear 45 traverses through the first and second through-holes 415 and 425, and engages with the first and second racks 412, 422 simultaneously. The gear 45 has a gear shaft 450 with two ends mounted into a first and second shaft sleeves 46 and 47. The locking switch device 4 is supported in the housing 1 by the first and second shaft sleeves 46 and 47.

The first and second buttons 410, 420 have a hollow housing shape and are provided with a first groove 416 and a second groove 426 respectively. The two grooves are respectively shown in FIGS. 5 and 6. In the assembled state, the first spring 43 is mounted between the first groove 416 and the second installation projection 424, and the second spring 44 is mounted between the second groove 426 and the first installation projection 414. Thus, under the action of the biased pressure of the first and second springs 43, 44, the first and second button components 41, 42 tend to move towards the opposite directions. When there is no outer force acting on the first and second buttons 410, 420, the two buttons are urged to extend out of the handle portion 13.

As shown in FIG. 4, when the user overcomes the biased pressure of the first spring 43 to press down the first button 410, the first rack 412 moves towards the interior of the housing 1 in the direction A and causes the gear 45 to rotate in a counter-clockwise direction. Since the gear 45 engages with the second rack 422 at the same time, the gear 45 then causes the second rack 422 to move automatically towards the interior of the housing 1 in the direction B by overcoming the biased pressure of the second spring 44. In contrast, when the user overcomes the biased pressure of the second spring 44 to press down the second button 420, the second rack moves towards the interior of the housing 1 in the direction B and causes the gear 45 to rotate in a counter-clockwise direction. Since the gear 45 engages with the first rack 412 at the same time, the gear 45 then causes the first rack 412 to move automatically towards the interior of the housing 1 in the direction A by overcoming the biased pressure of the first spring 43.

Consequently, no matter which one of the first and second buttons 410, 420 is pressed down by the user, the other one of the first and second button 410, 420 will move automatically towards the interior of the housing 1 to reach a position corresponding to a state of being pressed down. When the user releases the first button 410 or the second button 420 of the locking switch device 4, the restoring forces of the first and second spring 43, 44 bring the first and second buttons 410, 420 to automatically restore the buttons to the un-pressed state. This arrangement enables both the left-handed and the right-handed operators to manipulate the locking switch device very easily. Another advantage of this structure is that, when the user handles the handle portion 13 with his thumb located on one of the first and second buttons 410, 420 whereby the other one of the first and second buttons 410, 420 will be located in a position corresponding to the palm of the user, when the user presses down one button, the other one will move automatically towards the interior of the housing to reach the position of being pressed down, thus eliminating the uncomfortable feeling of handling the handle and conforming to the principles of the human engineering much better.

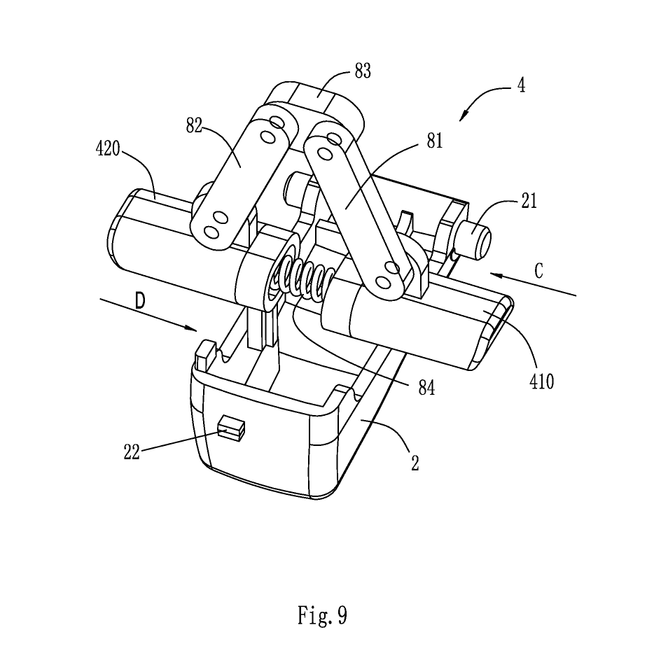

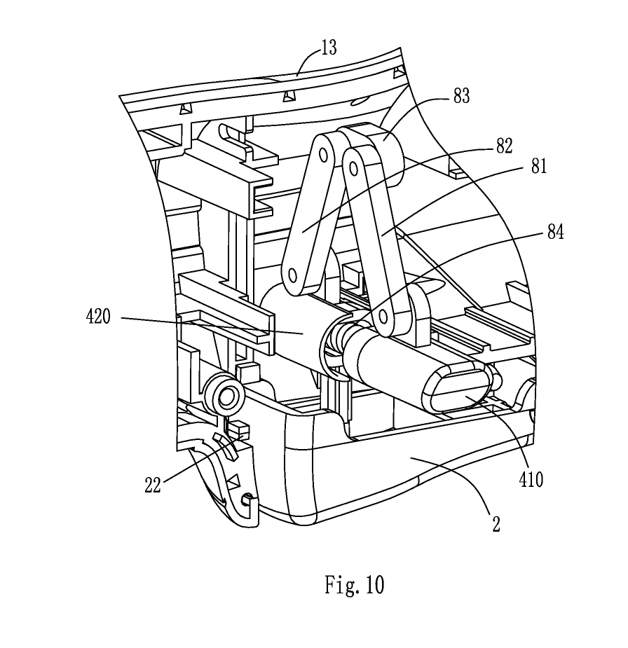

FIGS. 9 and 10 illustrate the further exemplary embodiment of a locking mechanism. In this embodiment, the linkage mechanism between the first and second buttons 410, 420 takes the form of a link mechanism. The link mechanism comprises a first link 81, a second link 82, and a sliding block 83. The first link 81 is pivotally connected to the first button 410 and the sliding block 83, and the second link 82 is pivotally connected between the second button 420 and the sliding block 83. The sliding block 83 can move upwards and downwards. A restoring member such as a spring 84 acts between the first and second buttons 410 and 420 and causes the first and second buttons 410 and 420 to tend to move oppositely. When there is no outer force acting on the first and second buttons 410 and 420, the two buttons are urged to extend out of the handle portion 13.

When the first button 410 is pressed down in the direction C, the first link 81 connected thereto moves and thus causes the sliding block 83 to move upwards and the sliding block 83 then causes the second link 82 connected thereto to move in the direction D, thereby the angle between the first and second links 81, 82 is reduced, and the second button 420 moves towards the housing to reach the position corresponding to a state of being pressed down under the movement of the second link 82. If the user presses down the second button 420, the first button will move automatically towards the housing to reach the position corresponding to the state of being pressed down under the action of the link mechanism. Thus, when the user presses down one button of the locking switch device, the other one will move automatically to reach the position of the state of being pressed down.

The power tool disclosed in the present invention is not limited to the structures shown in the drawings and the above contents. For example, the handle portion of the power tool may be formed onto the housing as a part of the housing, or may be a separate member connected to the housing by a connecting mechanism, and the locking mechanism between the locking switch device and the starting switch may use other structures. The linkage mechanism between the first and second buttons is also not limited to the gear-rack mechanism and link mechanism mentioned above, and other mechanisms, which enable one button to move automatically to be pressed down once the other one is pressed down, may also be used. It will be apparent to those skilled in the art that some changes, substitutes and modifications may be made in the shapes and positions of other members, which are still within the scope of this invention.

What is claimed is:

1. A power tool, comprising:
a power supply;
a housing including a handle portion on which is mounted a starting switch that is associated with the power supply for controlling the turning-on and turning-off of the power tool;
a locking switch device mounted in the housing comprising first and second buttons respectively extending out from the two sides of the handle portion and positioned adjacent to the starting switch, the locking switch being adapted to selectively inhibit movement of the starting switch; and
a locking mechanism arranged between the starting switch and the locking switch device comprising a linkage mechanism arranged between the first and second buttons whereby, upon one of the first and second buttons being pressed down, the linkage mechanism causes the other one of the first and second buttons to be automatically moved to position corresponding to a pressed down state whereupon the starting switch is free to be moved to a state for turning-on the power tool.

2. The power tool according to claim 1, wherein the linkage mechanism comprises at lease one resilient member acting between the first and second buttons.

3. The power tool according to claim 2, wherein the at least one resilient member is at least one spring.

4. The power tool according to claim 2, wherein the linkage mechanism further comprises two gear-rack transmission pairs.

5. The power tool according to claim 4, wherein the two gear-rack transmission pairs comprise a gear and two racks, wherein the gear engages with the two racks simultaneously, and the two racks are connected to the first and second buttons respectively.

6. The power tool according to claim 2, wherein the linkage mechanism comprises a link mechanism.

7. The power tool according to claim 6, wherein the link mechanism comprises first and second links and a sliding block, the first and second links being connected to the first and second buttons respectively.

8. The power tool according to claim 1, wherein the locking mechanism is a lock-on and/or lock-off locking mechanism.

9. The power tool according to claim 8, wherein the locking mechanism comprises at least one butting portion located on the locking switch device and at least one block engageable with the butting portion located on the starting switch.
